(19) United States
(12) Patent Application Publication
(10) Pub. No.: US 2013/0097089 A1
(43) Pub. Date: Apr. 18, 2013

(54) SYSTEM TO IDENTIFY MULTIPLE COPYRIGHT INFRINGEMENTS

(71) Applicant: Robert STEELE, Santa Monica, CA (US)

(72) Inventor: Robert STEELE, Santa Monica, CA (US)

(21) Appl. No.: 13/437,756

(22) Filed: Apr. 2, 2012

Related U.S. Application Data
(60) Provisional application No. 61/470,541, filed on Apr. 1, 2011.

(51) Int. Cl. G06Q 50/18

(52) U.S. Cl. CPC G06Q 50/184
USPC 705/310

(57) ABSTRACT

A system, a method and a computer program for determining multiple copyright infringement events, identifying a particular IP address-port number combination associated with the multiple infringement events, and notifying an ISP and/or a customer regarding the multiple copyright infringement events.

### CROSS REFERENCE TO PRIOR APPLICATIONS

This application claims priority to and the benefit thereof from U.S. Provisional Patent Application No. 61/470,541, filed on Apr. 1, 2011, titled “System to Identify Multiple Copyright Infringements,” the entirety of which is hereby incorporated herein by reference.

### FIELD OF THE DISCLOSURE

The present disclosure relates to a system, a method, and a computer program for identifying multiple copyright infringements.

### BACKGROUND OF THE DISCLOSURE

Digital piracy of copyright material is a substantial, worldwide problem for the music industry. For example, according to the International Federation of the Phonographic Industry (IFPI) Digital Music Report 2011, digital piracy has substantially contributed to the erosion of music industry revenues. The IFPI reports that global recorded music revenues declined by 31% from 2004-2010 as a result of such piracy. The IFPI has found that while some peer-to-peer sharing networks such as Limewire are in decline, the use of other peer-to-peer sharing networks such as BitTorrent are on the rise. Similarly, the Nielsen Company reports that nearly one in four active internet users in Europe visit unlicensed content sites monthly. Although copyright infringement appears to be widespread, most acts of copyright infringement are carried out by a small number of individuals. In order to combat this problem, governments from around the world are beginning to shift some of the burden to internet service providers (hereinafter “ISPs”) to address acts of piracy occurring on their networks.

Established in 1997, the Digital Millenium Copyright Act (DMCA), which is also known as the “No Electronic Theft” Act, heightened the penalties for copyright infringement on the Internet and established the liability of the providers of on-line services of copyright infringement by their users. The Act outlawed the manufacture, sale, or distribution of code-cracking devices used to illegally copy software. The Act states that service providers may not allow the illegal downloading of copyright materials by means of their systems.

In trying to combat peer-to-peer copyright infringement, the music industry, for example, has spent millions of dollars searching for a technology breakthrough to protect copyrighted works. These technologies often include Digital Rights Management (DRM). DRM technologies attempt to prevent digital music player technology from allowing reproduction of the copyrighted works. However, DRM technologies generally suffer from the problem that if a reasonably talented technology person can listen to a music file, then that person can likely find a way to make a copy that does not have the DRM technology. Similarly, problems also exist with multimedia content copy prevention that are currently available.

The disclosure provides a novel system, method, and computer program to facilitate the recapture of lost revenue, which results from copyright infringement. In particular, the novel system, method and computer program include identification of acts of copyright infringement, documentation of the details surrounding the acts of copyright infringement, and notice of the copyright infringement to ISPs.

### SUMMARY OF THE DISCLOSURE

Accordingly, one aspect of the present disclosure provides a system, a method, and a computer program that may mine a data stream of infringement data over a period of time, process the mined data to find correlations in the data, and identify specific sets of IP addresses and ports associated with acts of copyright infringement. The system, method and computer program are further configured to notify ISPs of repeat copyright infringers, including an identification of an IP address and a port number.

Another aspect of the disclosure provides a system for detecting copyright infringement, comprising: a retrieving module configured to retrieve a library of nodes from a storage device; an identifying module configured to identify additional nodes and update the library of nodes to further include the additional nodes; and, a querying module configured to query the library of nodes to determine if the nodes include one or more predetermined files, wherein the one or more predetermined files may include copyrighted material, wherein the copyrighted material may include a text file, audio file, video file, and/or a multimedia file; a database populating module configured to populate a database with results of the query if the results include infringement data, wherein the infringement data is subsequently maintained within the database as a database record, wherein the infringement data includes at least one of an IP address, a port number, a file name, a time stamp, a software version number, and/or an ISP identifier; a correlation module configured to correlate database records in order to identify records having a predetermined relationship; a clustering module configured to generate a data structure to facilitate clustering of all records having the predetermined relationship; and, a notification module configured to transmit a notification to an ISP once the number of records in the data structure exceeds a predetermined threshold.

The notification may include at least a portion of the infringement data and/or a reference to the predetermined relationship.

The notification may include updating a file, data structure, or database record.

The predetermined relationship may be defined as two or more records having substantially the same IP address.

Alternatively, the predetermined relationship may be defined as two or more records having substantially the same port number.

Alternatively, the predetermined relationship may be defined as two or more records having an IP address and port number combination that includes substantially the same IP address and substantially the same port number, respectively.

The system may also include a reporting module configured to provide the ISP with an internet dashboard populated with ISP infringing data.

The infringement data may include one or more of a number of infringement events for a given time period, a number of unique IP address and port number combinations during the time period, the number of infringement events associated with each unique IP address and port number combination, the infringement data for each infringement event, and/or reconciliation data.

The reconciliation data may include at least one of information regarding any payment that may have been received for a particular infringement event, whether the payment was forwarded to the copyright owner, and/or the identity of the copyright owner.

Another aspect of the disclosure provides a method for detecting copyright infringement, comprising: determining if a node is distributing copyrighted material; and, identifying an IP address and port number associated with one or more acts of copyright infringement.

The method may also include communicating a file transfer request to a node, wherein the file transfer request comprises a request to receive a copy of the copyrighted material; and, receiving a response that indicates the node will provide a copy of the copyrighted material.

The method may also include populating a database with infringement data associated with the received response, wherein the infringement data is maintained within the database as a database record.

The method may also include correlating the database records in order to identify records having substantially the same IP address and port number combination.

The method may also include clustering records having substantially the same IP address and port number combinations, wherein the step of clustering further comprises generating a data structure to facilitate the clustering of records.

The method may also include transmitting a notification to an ISP that informs the ISP of the one or more acts of copyright infringement.

The method may also include providing the ISP with an internet dashboard populated with ISP infringing data.

Another aspect of the present disclosure provides a computer readable medium including instructions, which when executed by one or more computers, causes the one or more computers to perform a method to detect copyright infringement, the instructions comprising: instructions for identifying one or more nodes; instructions for querying the one or more nodes to determine if the nodes include copyrighted material; instructions for populating records of a database with the query results; instructions for mining the database to identify all records having an IP address and port number combination, wherein the each IP address and port number combination includes substantially the same IP address and substantially the same port number; and, instructions for generating one or more data structures that may be used to cluster records, based at least in part, on an associated IP address and port number combination.

The computer readable medium may also include instructions for transmitting a notification to an ISP once the number of records in a cluster exceeds a predetermined threshold.

The notification may include a reference to the IP address and port number combination.

The computer readable medium may also include instructions for providing the ISP with an internet dashboard populated with ISP infringing data.

The ISP infringing data may include one or more of a number of infringement events for a given time period, a number of unique IP address and port number combinations during the time period, the number of infringement events associated with each unique IP address and port number combination, the infringement data for each infringement event, and/or reconciliation data.

Additional features, advantages, and embodiments of the disclosure may be set forth or apparent from consideration of the detailed description, drawings and attachment. Moreover, it is to be understood that the foregoing summary of the disclosure and the following detailed description, drawings and attachment are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate embodiments of the disclosure and together with the detailed description and attachment serve to explain the principles of the disclosure. No attempt is made to show structural details of the disclosure in more detail than may be necessary for a fundamental understanding of the disclosure and the various ways in which it may be practiced. In the drawings:

FIG. 1 shows an example of a system for identifying multiple copyright infringements; and

FIG. 2 shows an example of a process for detecting acts of copyright infringement and identifying repeat infringers.

The present disclosure is further described in the detailed description that follows.

### DETAILED DESCRIPTION OF THE DISCLOSURE

The disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

A “computer”, as used in this disclosure, means any machine, device, circuit, component, or module, or any system of machines, devices, circuits, components, modules, or the like, which are capable of manipulating data according to one or more instructions, such as, for example, without limitation, a processor, a microprocessor, a central processing unit, a general purpose computer, a super computer, a personal computer, a laptop computer, a palmtop computer, a notebook computer, a desktop computer, a workstation computer, a server, or the like, or an array of processors, microprocessors, central processing units, general purpose computers, super computers, personal computers, laptop computers, palmtop computers, notebook computers, desktop computers, workstation computers, servers, or the like.

A “server”, as used in this disclosure, means any combination of software and/or hardware, including at least one application and/or at least one computer to perform services for connected clients as part of a client-server architecture. The at least one server application may include, but is not limited to, for example, an application program that can accept connections to service requests from clients by sending back responses to the clients. The server may be configured to run the at least one application, often under heavy workloads, unattended, for extended periods of time with minimal human direction. The server may include a plurality of computers configured, with the at least one application being divided among the computers depending upon the workload. For example, under light loading, the at least one application can run on a single computer. However, under heavy loading, multiple computers may be required to run the at least one application. The server, or any if its computers, may also be used as a workstation.

A “database”, as used in this disclosure, means any combination of software and/or hardware, including at least one application and/or at least one computer. The database may include a structured collection of records or data organized according to a database model, such as, for example, but not limited to at least one of a relational model, a hierarchical model, a network model or the like. The database may include a database management system application (DBMS) as is known in the art. The at least one application may include, but is not limited to, for example, an application program that can accept connections to service requests from clients by sending back responses to the clients. The database may be configured to run the at least one application, often under heavy workloads, unattended, for extended periods of time with minimal human direction.

A “communication link”, as used in this disclosure, means a wired and/or wireless medium that conveys data or information between at least two points. The wired or wireless medium may include, for example, a metallic conductor link, a radio frequency (RF) communication link, an Infrared (IR) communication link, an optical communication link, or the like, without limitation. The RF communication link may include, for example, WiFi, WiMAX, IEEE 802.11, DECT, 0G, 1G, 2G, 3G or 4G cellular standards, Bluetooth, or the like.

A “network,” as used in this disclosure means, but is not limited to, for example, at least one of a local area network (LAN), a wide area network (WAN), a metropolitan area network (MAN), a personal area network (PAN), a campus area network, a corporate area network, a global area network (GAN), a storage area network (SAN), a broadband area network (BAN), a cellular network, the Internet, or the like, or any combination of the foregoing, any of which may be configured to communicate data via a wireless and/or a wired communication medium.

The terms “including”, “comprising” and variations thereof, as used in this disclosure, mean “including, but not limited to”, unless expressly specified otherwise.

The terms “a”, “an”, and “the”, as used in this disclosure, means “one or more”, unless expressly specified otherwise.

Devices that are in communication with each other need not be in continuous communication with each other, unless expressly specified otherwise. In addition, devices that are in communication with each other may communicate directly or indirectly through one or more intermediaries.

Although process steps, method steps, algorithms, or the like, may be described in a sequential order, such processes, methods and algorithms may be configured to work in alternate orders. In other words, any sequence or order of steps that may be described does not necessarily indicate a requirement that the steps be performed in that order. The steps of the processes, methods or algorithms described herein may be performed in any order practical. Further, some steps may be performed simultaneously.

When a single device or article is described herein, it will be readily apparent that more than one device or article may be used in place of a single device or article. Similarly, where more than one device or article is described herein, it will be readily apparent that a single device or article may be used in place of the more than one device or article. The functionality or the features of a device may be alternatively embodied by one or more other devices which are not explicitly described as having such functionality or features.

A “computer-readable medium”, as used in this disclosure, means any medium that participates in providing data (for example, instructions) which may be read by a computer. Such a medium may take many forms, including non-volatile media, volatile media, and transmission media. Non-volatile media may include, for example, optical or magnetic disks and other persistent memory. Volatile media may include dynamic random access memory (DRAM). Transmission media ay include coaxial cables, copper wire and fiber optics, including the wires that comprise a system bus coupled to the processor. Transmission media may include or convey acoustic waves, light waves and electromagnetic emissions, such as those generated during radio frequency (RF) and infrared (IR) data communications. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, a carrier wave as described hereinafter, or any other medium from which a computer can read.

Various forms of computer readable media may be involved in carrying sequences of instructions to a computer. For example, sequences of instruction (i) may be delivered from a RAM to a processor, (ii) may be carried over a wireless transmission medium, and/or (iii) may be formatted according to numerous formats, standards or protocols, including, for example, WiFi, WiMAX, IEEE 802.11, DECT, 0G, 1G, 2G, 3G or 4G cellular standards, Bluetooth, or the like.

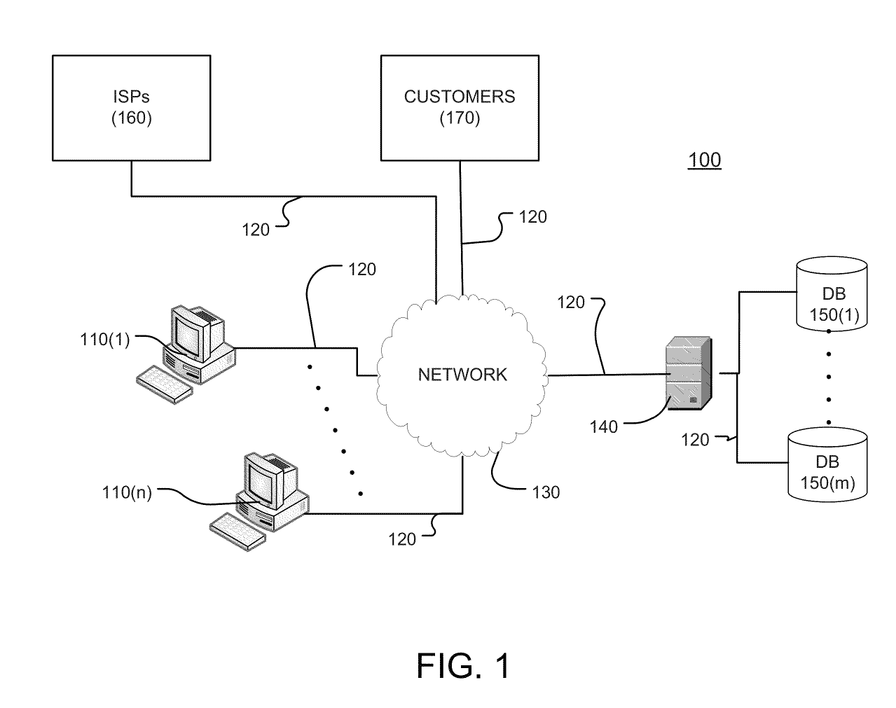

FIG. 1 shows an example of a system 100 for identifying multiple copyright infringements. The system 100 includes a plurality of Peer-to-Peer (P2P) computers 110(1) to 110(n) (where n is a positive, non-zero integer), a network 130, a server (or computer) 140, one or more databases 150(1) to 150(m) (where m is a positive, non-zero integer), one or more ISPs 160, and one or more customers 170. The server 140 and database(s) 150 may be connected to each other and/or the network 130 via one or more communication links 120. The P2P computers 110, the ISPs 160, and the customers 170 may be coupled to the network 130 via communication links 120. The customers 170 may include, for example, but are not limited to, individuals, privately owned entities, corporations, government agencies (e.g., the Department of Justice), or the like. The ISPs 160 may each be provided with a unique login identification and password to access a virtual space allocated to the particular ISP 160, which may include a portion of, or an entire, database 150. Similarly, the customer 170 may each be provided with a unique login identification and password to access a virtual space allocated to the particular customer 170, which may include a portion of, or an entire database 150.

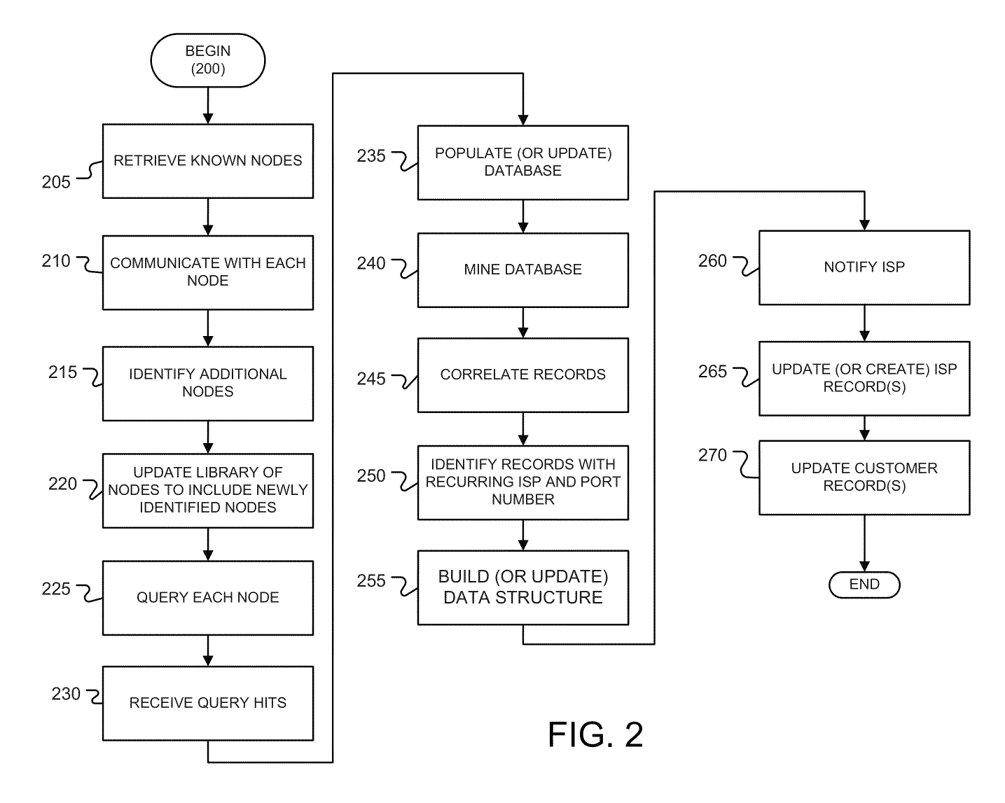

FIG. 2 shows an example of a process 200 for detecting acts of copyright infringement and identifying repeat infringers. The process 200 may be carried out, for example, by the server 140.

The process of FIG. 2 begins at step 205 by retrieving all known nodes in order to generate a library of nodes. A node may include, e.g., any device that is an endpoint of data transmission or reception across a network. The node may be associated with, e.g., an IP address and/or a port. The library of known nodes may be retrieved from, e.g., local storage or remote storage. The library of known nodes may be retrieved, e.g., from a BitTorrent network. Then, at step 210, a signal may be sent to each of the nodes (or fewer than all of the nodes) in the library of nodes in an attempt to discover additional nodes. This signal may comprise, e.g., a query for additional nodes.

In response to the query, a response signal comprising, e.g., the results of the query, may be received from each of the nodes. In step 215, the process interprets the response signal and determines if the response signal includes an identification of one or more additional nodes. If an additional node is identified, the identifications of the one or more additional nodes may be added to the library of known nodes in step 220 and stored in, for example, local storage thereby providing the capability to update the library of known nodes.

After updating the library of nodes, step 225 provides that each of the nodes in the updated list of nodes may be queried to determine if the nodes include one or more predetermined files. Such a query may include, e.g., a request to receive a copy of the predetermined file. For purposes of this disclosure, it is contemplated that the predetermined file may include copyrighted material including, for example, a text file, an audio file, a video file, a multimedia file, or the like. The query of step 225 may include a keyword, a number, an alphanumeric character, or the like.

In step 230, one or more query hits may be received from the queried nodes. A query hit may include, e.g., a response to the query that indicates that the node will provide a copy of the copyrighted material. Such a response may thereby constitute an act of copyright infringement. Alternatively, or in addition, each query hit may include, e.g., infringement data. The infringement data may include, e.g., an IP address, a port number, a file name, a time stamp, a software version of the peer-to-peer software used to download (or upload) the copyrighted material, an ISP identifier, or the like. Then, at step 235 a database 150 may be populated with data associated with the received query hit including, e.g., infringement data.

After the database has been populated with the infringement data, the database may be mined in step 240. In particular, each of the records in the database may be retrieved and analyzed or a query may be submitted to the database to return particular records containing infringement data. At step 245, all of the records (or a portion of all records) are correlated in order to cluster, or group together, all records having a predetermined relationship. The predetermined relationship may be, e.g., a same, or substantially the same, IP address and port number combination. As a result of the correlating process, it is possible to easily identify all records (or a portion of all records) that have the same, or substantially the same, predetermined relationship.

In order to facilitate efficient organization and maintenance of the clustered records, one or more data structures may be generated and populated with the identified records having the same, or substantially the same, IP address and port number combination at step 255. The data structure may be, e.g., a table, an array, a list, a linked list, a tree structure, or the like. If a corresponding data structure already exists, then the data structure may be updated with any newly identified records.

At step 260, an ISP may be notified when one or more acts of copyright infringement have been detected. Such an ISP may be notified, e.g., when a single act of copyright infringement has been detected. Alternatively, the method could be implemented in a manner that focuses on only notifying an ISP when a repeat infringer has been detected.

A repeat infringer may be detected by monitoring a predetermined threshold associated with the number of entries populating each generated data structure. For example, the method may provide that once a predetermined number (such as, for example, 5, 10, 20, or any positive number greater than 1) of data structure entries are identified that have substantially the same IP address and substantially the same port number, the ISP 160 associated with the IP address may be notified.

The notification may be in the form of a communication such as, for example, an email, a text message, a data transmission, voice message, mailed letter or the like, and may include one or more of the IP address, the port number, and a time stamp. Alternatively, or in addition, the notification may include, e.g., updating a file, a data structure, a record, metadata, or the like, with at least a portion of the infringement data, including one or more of the IP address, the port number, the file name, and the time stamp, which may be accessed by the ISP.

In addition, or alternatively, the ISP may be provided with, e.g., a dashboard that is populated with ISP infringing data. The ISP infringing data may include, e.g., a total number of infringement events for a given time period (e.g., a second, a minute, an hour, a day, a week, a month, a year, a time range, a date range, or the like), the total number of unique IP address-port number combinations during the time period, the number of infringement events associated with each unique IP address-port number combination, the infringement data for each infringement event, or the like.

The ISP infringing data may further include reconciliation data. The reconciliation data may include information regarding any payment that may have been received for a particular infringement event, whether the payment was forwarded to a copyright owner, the identity of the copyright owner, or the like.

After the ISP 160 has been notified in step 260, the record(s) (or profile) that is associated with the particular ISP may be updated with the entries of the associated data structure in step 265. If a record does not exist for the particular ISP, then a record may be created.

A customer notification including customer data may be communicated to the customer 170. Such a customer data may be used, e.g., to update customer records in step 270. The customer notification may be in the form of an electronic communication such as, for example, an email, a text message, a data transmission, voice message, mailed letter or the like, and may include the customer data. The customer data may include infringement data for each ISP and/or unique IP address and port number combinations, including, for example: an identification of the ISP, the number of unique IP address and port number combinations, the number of infringing events associated with each unique IP address and port number combination, the file names downloaded or uploaded by each unique IP address and port number combination, the dates and times of each of the infringing events that are associated with each IP address and port number combination, or the like. The customer notification data may further include historical data for each ISP, for each unique IP address and port number combination, for each file name, or the like.

The customer may be provided with, e.g., a dashboard that is populated with customer data. The customer data may further include, for example, a total number of infringement events for a given time period (e.g., a second, a minute, an hour, a day, a week, a month, a year, a time range, a date range, or the like), the total number of unique IP address-port number combinations during the time period, the number of infringement events associated with each unique IP address and port number combination, the infringement data for each infringement event, or the like.

The customer data may further include customer reconciliation data. The reconciliation data may include payment information (e.g., payment that may have been received for a particular infringement event), the IP address and port number combination associated with the infringement event, whether the IP address and port number is a repeat offender, whether the ISP has taken any action (e.g., sent a notice to the infringer, disconnected the infringer, or the like), the nature of the type of action taken, or the like.

According to an aspect of the disclosure, a computer readable medium is provided containing a computer program, which when executed on, e.g., the server 140, causes the process 200 in FIG. 2 to be executed. The computer program may be tangibly embodied in the computer readable medium, comprising one or more program instructions, code segments, or code sections for performing steps 205 through 270 when executed, e.g., the server 140.

According to a non-limiting example of the disclosure, the system 100 may collect data unique to each peer and look for patterns in this data to group a series of infringements acquired over time into lists. These lists should have greater than 99% probability of having come from the same computer. More than, e.g., twenty unique types of data used for this grouping include the file list and port number of the peer as well as settings unique to the operating system such as the setting of the FIN probe, BOGUS flag probe, TCP ISN Sampling, IPID sampling in the IP packets. In between IP address rotations, the port number is a useful index for grouping potentially matching infringement records. For example, a port 6348 may show up on 0.55% of infringement records. Of the 65,536 possible ports only two have a more than a 1% chance of appearing on any given infringement records. When the system 100 then analyzes a list of potentially matching infringement records by file list, the probability goes up by several decimal points of accuracy. For example, metadata on P2P networks is ad-hoc and non-uniform. The system 100 technology may include machine learning to assign a network of probabilities to a very large pool of file lists obtained from peers. In many cases a file list containing, e.g., 1,000 songs may be identical on two different infringement records that occur on different IP addresses. This gives a high probability that these two infringement records were from the same computer. If the system 100 can also see that prior to a certain date these file lists were all on IP address X (where X is an IP address) and port Y (where Y is a port number) and after a certain date, these infringements were all on IP address W (where W is an IP address) and port Z (where Z is a port number), there is a very high probability that these file lists are the same computer.

While the disclosure has been described in terms of exemplary embodiments, those skilled in the art will recognize that the disclosure can be practiced with modifications in the spirit and scope of the appended claims. These examples are merely illustrative and are not meant to be an exhaustive list of all possible designs, embodiments, applications or modifications of the disclosure.

What is claimed is:

1. A system for detecting copyright infringement, comprising:
a retrieving module configured to retrieve a library of nodes from a storage device;
an identifying module configured to identify additional nodes and update the library of nodes to further include the additional nodes;
a querying module configured to query the library of nodes to determine if the nodes include one or more predetermined files, wherein the one or more predetermined files may include copyrighted material, wherein the copyrighted material may include a text file, audio file, video file, and/or a multimedia file;
a database populating module configured to populate a database with results of the query if the results include infringement data, wherein the infringement data is subsequently maintained within the database as a database record, wherein the infringement data includes at least one of an IP address, a port number, a file name, a time stamp, a software version number, and/or art ISP identifier;
a correlation module configured to correlate database records in order to identify records having a predetermined relationship;
a clustering module configured to generate a data structure to facilitate clustering of all records having the predetermined relationship; and,
a notification module configured to transmit a notification to an ISP once the number of records in the data structure exceeds a predetermined threshold.

2. The system of claim 1, wherein the notification includes at least a portion of the infringement data and a reference to the predetermined relationship.

3. The system of claim 1, wherein the notification includes updating a file, a data structure, or a database record,

4. The system of claim 1, wherein the predetermined relationship is defined as two or more records having substantially the same IP address.

5. The system of claim 1, wherein the predetermined relationship is defined as two or more records having substantially the same port number.

6. The system of claim 1, wherein the predetermined relationship is defined as two or more records having an IP address and port number combination that includes substantially the same IP address and substantially the same port number.

7. The system of claim 1, further comprising:
a reporting module configured to provide the ISP with an internet dashboard populated with ISP infringing data.

8. The system of claim 7, wherein the ISP infringing data includes one or more of a number of infringement events for a given time period, a number of unique IP address and port number combinations during the time period, the number of infringement events associated with each unique IP address and port number combination, the infringement data for each infringement event, or reconciliation data.

9. A method for detecting copyright infringement, comprising:
determining if a node is distributing copyrighted material; and,
identifying an IP address and port number associated with one or more acts of copyright infringement.

10. The method of claim 9, wherein the step of determining further comprises:
communicating a file transfer request to a node, wherein the file transfer request comprises a request to receive a copy of the copyrighted material; and,
receiving a response that indicates the node will provide a copy of the copyrighted material.

11. The method of claim 10, wherein the method further comprises:
populating a database with infringement data associated with the received response, wherein the infringement data is maintained within the database as a database record.

12. The method of claim 11, wherein the method further comprises:
correlating the database records to identify records having the same, or substantially similar, IP address and port number combinations.

13. The method of claim 12, wherein the method further comprises:
clustering records having substantially the same IP address and port number combination, wherein the step of clustering further comprises generating a data structure to facilitate the clustering of records.

14. The method of claim 9, wherein the method further comprises:
transmitting a notification to an ISP that informs the ISP of the one or more acts of copyright infringement.

15. The method of claim 14, wherein the method further comprises:
providing the ISP with an internet dashboard populated with ISP infringing data.

16. A computer readable medium including instructions, which when executed by one or more computers, causes the one or more computers to perform a method to detect copyright infringement, the instructions comprising:
instructions for identifying one or more nodes;
instructions for querying the one or more nodes to determine if the nodes include copyrighted material;
instructions for populating records of a database with the query results;
instructions for mining the database to identify all records having substantially the same IP address and port number combination; and,
instructions for generating one or more data structures that may be used to cluster records, based at least in part, on an associated IP address and port number combination.

17. The computer readable medium of claim 16, wherein the instructions further comprise:
instructions for transmitting a notification to an ISP once the number of records in a cluster exceeds a predetermined threshold.

18. The computer readable medium of claim 17, wherein the notification includes a reference to the IP address and port number combination.

19. The computer readable medium of claim 17, wherein the instructions further comprise:
instructions for providing the ISP with an internet dashboard populated with ISP infringing data.

20. The computer readable medium of claim 19, wherein the ISP infringing data may include one or more of a number of infringement events for a given time period, a number of unique IP address and port number combinations during the time period, the number of infringement events associated with each unique IP address and port number combination, the infringement data for each infringement event, and/or reconciliation data.

21. The system of claim 8, wherein the reconciliation data includes at least one of information regarding any payment that may have been received for a particular infringement event, whether the payment was forwarded to the copyright owner, and the identity of the copyright owner.
